(19) United States
(12) Patent Application Publication
(10) Pub. No.: US 2025/0286073 A1
(43) Pub. Date: Sep. 11, 2025

(54) POSITIVE ELECTRODE ADDITIVE, POSITIVE ELECTRODE PLATE CONTAINING POSITIVE ELECTRODE ADDITIVE, AND SECONDARY BATTERY

(71) Applicant: Ningde Amperex Technology Limited, Ningde (CN)

(72) Inventor: Chun LI, Ningde (CN)

(73) Assignee: Ningde Amperex Technology Limited, Ningde (CN)

(21) Appl. No.: 19/074,468

(22) Filed: Mar. 10, 2025

(30) Foreign Application Priority Data
Mar. 11, 2024 (CN) 202410275665.7

(51) Int. Cl. H01M 4/62; H01M 4/02; H01M 4/131; H01M 10/0525

(52) U.S. Cl. CPC H01M 4/628; H01M 4/131; H01M 4/623; H01M 10/0525; H01M 2004/028

(57) ABSTRACT

A positive electrode additive includes a polymer represented by Formula I, where, n≥162, m≥300, and a number-average molecular weight of the polymer represented is 6.7×10⁴ to 2×10⁸. The positive electrode additive possesses a high molecular polarity, high flexibility, a relatively low glass transition temperature, high adhesiveness, a high oxidation resistance, and a high conductivity. When applied to the positive electrode plate, the positive electrode additive can increase the cohesive force of the positive electrode material layer and reduce the expansion rate of the positive electrode plate, so that a secondary battery with a relatively high energy density can be obtained at a relatively low compaction density.

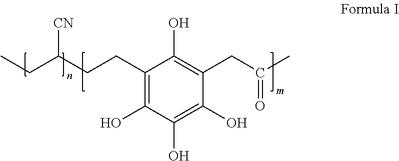

### CROSS-REFERENCE TO RELATED APPLICATION

This application claims priority to Chinese Patent Application No. 202410275665.7, filed on Mar. 11, 2024, the content of which is incorporated herein by reference in its entirety.

### TECHNICAL FIELD

This application relates to the field of electrochemical technology, and in particular, to a positive electrode additive, a positive electrode plate containing the positive electrode additive, a secondary battery, and an electronic device.

### BACKGROUND

Secondary batteries such as a lithium-ion battery are widely used in the fields such as smartphones, wearable devices, consumable unmanned aerial vehicles, and electric vehicles by virtue of advantages such as a high energy density, a long cycle life, and no memory effect. With the extensive application of lithium-ion batteries in the above fields, the requirements on the energy density and cycle performance of the lithium-ion batteries are increasingly higher in the market.

Polyvinylidene fluoride (PVDF) is typically used as a positive electrode binder of a lithium-ion battery. However, during the long-term cycling of the lithium-ion battery, the energy density of the lithium-ion battery is impaired because a positive electrode plate prepared from a PVDF binder possesses a relatively low cohesive force and exhibits a large rebound of thickness expansion.

### SUMMARY

An objective of this application is to provide a positive electrode additive, a positive electrode plate containing the positive electrode additive, a secondary battery, and an electronic device to increase the energy density of the secondary battery. Specific technical solutions are as follows:

A first aspect of this application provides a positive electrode additive. The positive electrode additive includes a polymer represented by Formula I:

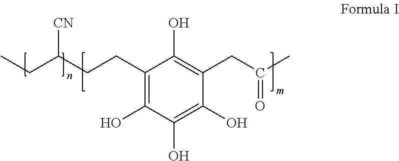

In the formula above, n≥162, m≥300, and a number-average molecular weight of the polymer represented by Formula I is 6.7×10⁴ to 2×10⁸. The positive electrode additive possesses a high molecular polarity, high flexibility, a relatively low glass transition temperature, high adhesiveness, a high oxidation resistance, and a high conductivity. When applied to the positive electrode plate, the positive electrode additive can increase the cohesive force of the positive electrode material layer and reduce the expansion rate of the positive electrode plate, so that the secondary battery achieves a relatively high energy density at a relatively low compaction density, thereby reducing the risk of particle crumbling of the positive active material, improving stability of the positive electrode material layer at high voltage (voltage ≥4.5 V, such as 4.5 V or 4.8 V), and in turn, increasing the energy density of the secondary battery and improving the intermittent cycle performance of the secondary battery.

In some embodiments of this application, 1.85≤m/n≤3. By controlling the value of m/n within the above range, the molecules of the positive electrode additive are endowed with a relatively high polarity and a relatively low glass transition temperature, thereby reducing the rigidity of the polymer network, and improving the flexibility of the polymer network. Therefore, the positive electrode additive applied to the positive electrode plate can increase the cohesive force of the positive electrode material layer, thereby increasing the energy density of the secondary battery and improving intermittent cycle performance of the secondary battery.

In some embodiments of this application, a glass transition temperature of the polymer represented by Formula I is −20° C. to 10° C. The glass transition temperature of the polymer represented by Formula I falls within the above range, indicating that the molecular weight flexibility of the positive electrode additive is relatively high. The positive electrode additive applied to the positive electrode plate can improve the flexibility of the positive electrode plate and improve the processing performance of the positive electrode plate.

A second aspect of this application provides a positive electrode plate. The positive electrode plate includes a positive current collector and a positive electrode material layer disposed on at least one surface of the positive current collector. The positive electrode material layer includes a positive active material, a fluorine-containing binder, and the positive electrode additive according to the first aspect of this application. The positive electrode material layer includes the polymer represented by Formula I. On the one hand, A catechol-modified group (

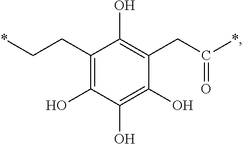

denoted as R) in the polymer is of an extremely low water absorptivity, thereby alleviating the problem that the internal resistance is increased due to a high water content of the electrode plate. On the other hand, a strong hydrogen bond C—F—H—O—R can be formed between the fluorine-containing binder and the catechol-modified group in the positive electrode additive. The strong hydrogen bond is a strong electrostatic attraction, and the intermolecular force of the bond is up to one-fourth of a covalent bond, and is 20 times the ordinary hydrogen bond force. The strong hydrogen bond can improve the bonding properties of the fluorine-containing binder. However, due to the excessively strong hydrogen bond force, the formed bonding network is rigid and detrimental to improving the flexibility of the positive electrode plate. In addition, the polymer represented by Formula I also includes an acrylonitrile group

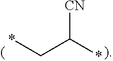 [SMILES: *CC(*)C#N]

The acrylonitrile group includes a flexible long-chain carbon, and can reduce the rigidity of the bonding network. The acrylonitrile group also includes a cyano group to improve the oxidation resistance and conductivity of the positive electrode additive, so that the positive electrode additive is applicable to secondary batteries at a high voltage. Therefore, the positive electrode material layer includes the positive electrode additive, so that not only the strong electrostatic attraction of the positive electrode additive can be used to increase the cohesive force of the positive electrode material layer and reduce the expansion rate of the positive electrode plate, but also the positive electrode additive can improve the stability of the positive electrode material layer at high voltage and provide a conductive channel. In addition, the positive electrode additive is conducive to the processing performance of the positive electrode plate, and therefore, can endow the secondary battery with a relatively high energy density at a relatively low compaction density and improve the intermittent cycle performance of the secondary battery.

In some embodiments of this application, a mass percent of the positive electrode additive is A %, satisfying: 0.1≤A≤0.5. Controlling the value of A within the above range can increase the cohesive force of the positive electrode material layer, endow the secondary battery with a relatively high energy density at a relatively low compaction density, and improve the intermittent cycle performance of the secondary battery.

In some embodiments of this application, a specific surface area of the positive active material is S m²/g, satisfying: 0.1≤S≤1, and 0.02≤A×S≤0.15. Controlling the values of S and A×S within the above ranges can exert the effect of the positive electrode additive to a greater extent, increase the cohesive force of the positive electrode material layer, endow the secondary battery with a relatively high energy density at a relatively low compaction density of the positive electrode plate, and reduce the risk of particle crumbling of the positive active material. Therefore, when applied to a secondary battery, the positive electrode plate can increase the energy density of the secondary battery and improve the intermittent cycle performance of the secondary battery.

In some embodiments of this application, the fluorine-containing binder includes at least one selected from the group consisting of aluminum trifluoride, polytetrafluoroethylene, poly(vinylidene fluoride-co-hexafluoropropylene), and polyvinylidene fluoride. Based on a mass of the positive electrode material layer, a mass percent of the fluorine-containing binder is B %, satisfying: 0.8≤B≤1.5. With the value of B controlled within the range specified herein, the fluorine-containing additive falling within the above range can form a strong hydrogen bond with the positive electrode additive to improve the bonding performance. The strong hydrogen bond can increase the cohesive force of the positive electrode material layer, reduce the expansion rate of the positive electrode plate, improve the stability of the positive electrode material layer at high voltage, and therefore, can endow the secondary battery with a relatively high energy density at a relatively low compaction density and improve the intermittent cycle performance of the secondary battery.

In some embodiments of this application, an X-ray diffraction pattern of powder of the positive electrode material layer exhibits quadruple characteristic peaks in a diffraction angle range of 40° to 55°. The quadruple characteristic peaks exhibited in the above diffraction angle range indicate that a strong hydrogen bond exists in the positive electrode material layer. Therefore, the strong hydrogen bond can work to increase the cohesive force of the positive electrode material layer, reduce the expansion rate of the positive electrode plate, improve the stability of the positive electrode material layer at high voltage, endow the secondary battery with a relatively high energy density at a relatively low compaction density of the positive electrode material layer, and improve the intermittent cycle performance of the secondary battery.

In some embodiments of this application, a cohesive force of the positive electrode material layer is 45 N/m to 95 N/m. Controlling the cohesive force of the positive electrode material layer within the above range can reduce the expansion rate of the positive electrode plate, and reduce the risk of detachment of the positive electrode material layer, thereby endowing the secondary battery with a relatively high energy density and improving the intermittent cycle performance of the secondary battery.

A third aspect of this application provides a secondary battery. The secondary battery includes the positive electrode plate according to the second aspect of this application. The positive electrode plate provided in this application exhibits a relatively low expansion rate, so that the secondary battery provided in this application achieves a relatively high energy density and superior intermittent cycle performance.

A fourth aspect of this application provides an electronic device. The electronic device includes the secondary battery according to the third aspect of this application. The secondary battery provided in this application possesses a relatively high energy density and superior intermittent cycle performance, and therefore, the electronic device provided in this application possesses a relatively long service life.

Some of the beneficial effects of this application are as follows:

This application provides a positive electrode additive, a positive electrode plate containing the positive electrode additive, a secondary battery, and an electronic device. The positive electrode additive includes a polymer represented by Formula I, where, n≥162, m≥300, and a number-average molecular weight of the polymer represented by Formula I is 6.7×10⁴ to 2×10⁸. The positive electrode additive possesses a high molecular polarity, high flexibility, a relatively low glass transition temperature, high adhesiveness, a high oxidation resistance, and a high conductivity. When applied to the positive electrode plate, the positive electrode additive can increase the cohesive force of the positive electrode material layer and reduce the expansion rate of the positive electrode plate, so that a secondary battery with a relatively high energy density can be obtained at a relatively low compaction density, thereby reducing the risk of particle crumbling of the positive active material, and improving stability of the positive electrode material layer at high voltage. When applied to a secondary battery, the positive electrode plate can increase the energy density of the secondary battery and improve the intermittent cycle performance of the secondary battery.

Definitely, a single product or method in which the technical solution of this application is implemented does not necessarily achieve all of the above advantages concurrently.

### BRIEF DESCRIPTION OF DRAWINGS

To describe the technical solutions in some embodiments of this application or the prior art more clearly, the following outlines the drawings to be used in the description of some embodiments of this application or the prior art. Evidently, the drawings outlined below merely illustrate some embodiments of this application, and a person of ordinary skill in the art may derive other embodiments from the drawings.

FIG. 1 is an X-ray diffraction pattern of powder of a positive electrode material layer according to Embodiment 1-1;

FIG. 2 is an X-ray diffraction pattern of polyvinylidene fluoride (PVDF) powder; and

FIG. 3 is an X-ray diffraction pattern of powder of a positive electrode additive according to Embodiment 1-1.

### DETAILED DESCRIPTION

The following describes the technical solutions in some embodiments of this application clearly in detail with reference to the drawings appended hereto. Evidently, the described embodiments are merely a part of but not all of the embodiments of this application. All other embodiments derived by a person skilled in the art based on this application still fall within the protection scope of this application.

It is hereby noted that in the following description, this application is construed by using a lithium-ion battery as an example of the secondary battery, but the secondary battery of this application is not limited to the lithium-ion battery. Specific technical solutions are as follows:

A first aspect of this application provides a positive electrode additive. The positive electrode additive includes a polymer represented by Formula I:

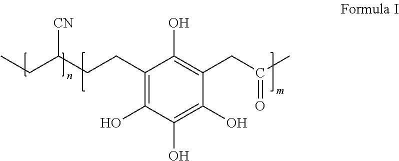

In the formula above, n≥162, m≥300, and a number-average molecular weight of the polymer represented by Formula I is 6.7×10⁴ to 2×10⁸. For example, the value of n may be 162, 200, 500, 1,000, 5,000, 8,000, 10,000, 14,000, 16,000, 20,000, 25,000, 50,000, 100,000, 200,000, 370,000, or a value falling within a range formed by any two thereof; the value of m may be 300, 500, 1,000, 5,000, 8,000, 10,000, 50,000, 100,000, 300,000, 500,000, 1,000,000, or a value falling within a range formed by any two thereof; and the number-average molecular weight of the polymer represented by Formula I is 6.7×10⁴, 10⁵, 5×10⁵, 10⁶, 5×10⁶, 10⁷, 5×10⁷, 10⁸, 2×10⁸, or a value falling within a range formed by any two thereof.

The applicant hereof finds that, when the value of m is excessively small, the content of the catechol-modified group is excessively low, and the content of the acrylonitrile group is excessively high, thereby being detrimental to increase of the cohesive force of the positive electrode material layer, and resulting in an excessively high expansion rate of the positive electrode plate. When the value of n is excessively small, the content of the acrylonitrile group is excessively low, and the content of the catechol-modified group is excessively high, thereby making the positive electrode plate brittle, and in turn, resulting in a narrower range of brittleness tolerance of the positive electrode plate after cold-pressing. This is detrimental to the processing performance of the positive electrode plate. When the number-average molecular weight of the polymer represented in Formula I is excessively small, the flexible groups in the positive electrode additive and the resultant strong hydrogen bonds are not enough to increase the cohesive force of the positive electrode material layer, thereby being detrimental to endowing the secondary battery with a relatively high energy density at a relatively low compaction density. Consequently, the risk of particle crumbling of the positive active material is relatively high, thereby being detrimental to improvement of the intermittent cycle performance and energy density of the lithium-ion battery. When the number-average molecular weight of the polymer represented by Formula I is excessively large, the crosslinkability of the positive electrode additive is excessively high. Due to the excessive steric hindrance of the hydroxyl group on the benzene ring in the polymer represented by Formula I, electrostatic repulsion is generated between the hydroxyl group and the cyano group, thereby resulting in relatively low electrophilicity of the hydroxyl group on the benzene ring, and reducing the reactivity and activity of the hydroxyl group on the benzene ring. Consequently, the formed strong hydrogen bonds are relatively few, and the cohesive force of the positive electrode material layer is not strong enough to alleviate the expansion of the positive electrode plate, thereby being detrimental to improvement of the intermittent cycle performance and energy density of the lithium-ion battery. The positive electrode additive possesses a high molecular polarity, high flexibility, a relatively low glass transition temperature, high adhesiveness, a high oxidation resistance, and a high conductivity. When applied to the positive electrode plate, the positive electrode additive can increase the cohesive force of the positive electrode material layer and reduce the expansion rate of the positive electrode plate, so that the secondary battery achieves a relatively high energy density at a relatively low compaction density, thereby reducing the risk of particle crumbling of the positive active material, improving stability of the positive electrode material layer at high voltage (voltage ≥4.5 V, such as 4.5 V or 4.8 V), and in turn, increasing the energy density of the secondary battery and improving the intermittent cycle performance of the secondary battery. In this application, the “relatively low compaction density” means that the positive electrode material layer containing the positive electrode additive of this application possesses a relatively low cold-pressing compaction density when the positive electrode material layer possesses an equivalent compaction density after cycling.

The method for preparing the positive electrode additive is not particularly limited herein, as long as the objectives of this application can be achieved. For example, the positive electrode additive may be polymerized from a

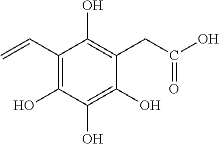 [SMILES: C=Cc1c(O)c(O)c(O)c(CC(=O)O)c1O]

monomer and an acrylonitrile monomer. The polymerization process is not particularly limited herein, and may be designed by a person skilled in the art as actually required, as long as the objectives of this application can be achieved.

In some embodiments of this application, 1.85≤m/n≤3. For example, the m/n ratio may be 1.85, 1.9, 2, 2.1, 2.2, 2.3, 2.4, 2.5, 2.6, 2.7, 2.8, 2.9, 3, or a value falling within a range formed by any two thereof. By controlling the value of m/n within the above range, the molecules of the positive electrode additive are endowed with a relatively high polarity and a relatively low glass transition temperature, thereby reducing the rigidity of the polymer network, and improving the flexibility of the polymer network. Therefore, the positive electrode additive applied to the positive electrode plate can increase the cohesive force of the positive electrode material layer, thereby increasing the energy density of the secondary battery and improving intermittent cycle performance of the secondary battery.

In some embodiments of this application, the glass transition temperature Tg of the polymer represented by Formula I is −20° C. to 10° C. For example, the glass transition temperature of the polymer represented by Formula I may be −20° C., −15° C., −12° C., −10° C., −5° C., 0° C., 3° C., 5° C., 8° C., 10° C., or a value falling within a range formed by any two thereof. The glass transition temperature of the polymer represented by Formula I falls within the above range, indicating that the molecular weight flexibility of the positive electrode additive is relatively high. The positive electrode additive applied to the positive electrode plate can improve the flexibility of the positive electrode plate and improve the processing performance of the positive electrode plate.

Generally, the value of the glass transition temperature Tg of the polymer represented by Formula I may be adjusted by adjusting the number-average molecular weight of the polymer represented by Formula I and the values of m and n. When other conditions remain unchanged, the larger the number-average molecular weight of the polymer represented by Formula I, the higher the value of Tg; the smaller the number-average molecular weight of the polymer represented by Formula I, the lower the value of Tg. When the value of n remains unchanged, the larger the m, the higher the Tg; the smaller the m, the lower the Tg. When the value of m remains unchanged, the larger the n, the lower the Tg; the smaller the n, the higher the Tg.

A second aspect of this application provides a positive electrode plate. The positive electrode plate includes a positive current collector and a positive electrode material layer disposed on at least one surface of the positive current collector. The positive electrode material layer includes a positive active material, a fluorine-containing binder, and the positive electrode additive according to the first aspect of this application. The positive electrode material layer includes the polymer represented by Formula I. On the one hand, A catechol-modified group (

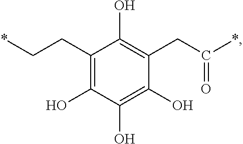

denoted as R) in the polymer is of an extremely low water absorptivity, thereby alleviating the problem that the internal resistance is increased due to a high water content of the electrode plate. On the other hand, a strong hydrogen bond C—F—H—O—R can be formed between the fluorine-containing binder and the catechol-modified group in the positive electrode additive. The strong hydrogen bond is a strong electrostatic attraction, and the intermolecular force of the bond is up to one-fourth of a covalent bond, and is 20 times the ordinary hydrogen bond force. The strong hydrogen bond can improve the bonding properties of the fluorine-containing binder. However, due to the excessively strong hydrogen bond force, the formed bonding network is rigid and detrimental to improving the flexibility of the positive electrode plate. In addition, the polymer represented by Formula I also includes an acrylonitrile group

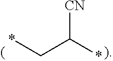 [SMILES: *CC(*)C#N]

acrylonitrile group includes a flexible long-chain carbon, and can reduce the rigidity of the bonding network. The acrylonitrile group also includes a cyano group to improve the oxidation resistance and conductivity of the positive electrode additive, so that the positive electrode additive is applicable to secondary batteries at a high voltage (voltage ≥4.5 V, such as 4.5 V or 4.8 V). Therefore, the positive electrode material layer includes the positive electrode additive, so that not only the strong electrostatic attraction of the positive electrode additive can be used to increase the cohesive force of the positive electrode material layer and reduce the expansion rate of the positive electrode plate, but also the positive electrode additive can improve the stability of the positive electrode material layer at high voltage and provide a conductive channel. In addition, the positive electrode additive is conducive to the processing performance of the positive electrode plate, and therefore, can endow the secondary battery with a relatively high energy density at a relatively low compaction density and improve the intermittent cycle performance of the secondary battery.

In some embodiments of this application, the mass percent of the positive electrode additive is A %, satisfying: 0.1≤A≤0.5. For example, the glass transition temperature of the polymer represented by Formula I may be 0.1, 0.15, 0.2, 0.25, 0.3, 0.35, 0.4, 0.45, 0.5, or a value falling within a range formed by any two thereof. Controlling the value of A within the above range can improve the processing performance of the positive electrode plate, exert the gravimetric capacity favorably, increase the cohesive force of the positive electrode material layer, reduce the expansion rate of the positive electrode plate, endow the secondary battery with a relatively high energy density at a relatively low compaction density, and improve the intermittent cycle performance of the secondary battery.

In some embodiments of this application, the specific surface area of the positive active material is S m²/g, satisfying: 0.1≤S≤1, and 0.02≤A×S≤0.15. For example, the value of S may be 0.1, 0.2, 0.3, 0.4, 0.5, 0.7, 0.9, 1, or a value falling within a range formed by any two thereof; and the value of A×S may be 0.02, 0.03, 0.05, 0.08, 0.1, 0.11, 0.12, 0.13, 0.14, 0.15, or a value falling within a range formed by any two thereof. Controlling the values of S and A×S within the above ranges can exert the effect of the positive electrode additive to a greater extent, endow the secondary battery with a relatively high energy density at a relatively low compaction density of the positive electrode plate, and reduce the risk of particle crumbling of the positive active material. Therefore, when applied to a secondary battery, the positive electrode plate can increase the energy density of the secondary battery and improve the intermittent cycle performance of the secondary battery.

In some embodiments of this application, the fluorine-containing binder includes at least one selected from the group consisting of aluminum trifluoride (AlF₃), polytetrafluoroethylene (PTFE), poly(vinylidene fluoride-co-hexafluoropropylene) (PVDF—HFP), and polyvinylidene fluoride (PVDF). Based on a mass of the positive electrode material layer, a mass percent of the fluorine-containing binder is B %, satisfying: 0.8≤B≤1.5. For example, the value of B may be 0.8, 0.9, 1, 1.1, 1.2, 1.3, 1.4, 1.5, or a value falling within a range formed by any two thereof. With the value of B controlled within the range specified herein, the fluorine-containing additive falling within the above range can form a strong hydrogen bond with the positive electrode additive to improve the bonding performance. The strong hydrogen bond can reduce the expansion rate of the positive electrode plate, improve the stability of the positive electrode material layer at high voltage, and therefore, can endow the secondary battery with a relatively high energy density at a relatively low compaction density and improve the intermittent cycle performance of the secondary battery.

In some embodiments of this application, an X-ray diffraction pattern of powder of the positive electrode material layer exhibits quadruple characteristic peaks in a diffraction angle range of 40° to 55°. The quadruple characteristic peaks exhibited in the above diffraction angle range in the X-ray diffraction pattern of the powder of the positive electrode material layer indicate that a strong hydrogen bond exists in the positive electrode material layer. Therefore, the strong hydrogen bond can work to increase the cohesive force of the positive electrode material layer, reduce the expansion rate of the positive electrode plate, improve the stability of the positive electrode material layer at high voltage, endow the secondary battery with a relatively high energy density at a relatively low compaction density of the positive electrode material layer, and improve the intermittent cycle performance of the secondary battery.

In some embodiments of this application, a cohesive force of the positive electrode material layer is 45 N/m to 95 N/m. For example, the cohesive force of the positive electrode material layer may be 45 N/m, 50 N/m, 60 N/m, 70 N/m, 75 N/m, 80 N/m, 85 N/m, 90 N/m, or 95 N/m, or a value falling within a range formed by any two thereof. Controlling the cohesive force of the positive electrode material layer within the above range can endow the positive electrode plate with relatively high structural stability, reduce the expansion rate of the positive electrode plate, and reduce the risk of detachment of the positive electrode material layer, thereby endowing the secondary battery with a relatively high energy density and improving the intermittent cycle performance of the secondary battery.

In this application, the X-ray diffraction pattern of the powder of the positive electrode material layer, the cohesive force of the positive electrode material layer, and the specific surface area S of the positive active material are measured for a secondary battery that has been cycled and disassembled. The cycling process is: charging the secondary battery at a 0.2 C rate until the voltage rises from 3 V to 4.52 V in a 25±5° C. environment and reaches a full charge state, and then discharging the secondary battery at 0.2 C until the voltage drops to 3 V. In this application, the number of cycles undergone by the secondary battery with the above parameters measured may be 1 to 100 cycles. After completing such cycles, the secondary battery is disassembled, and the positive electrode plate is taken out to measure the above parameters. The test process is not particularly limited herein, and a person skilled in the art may select a test method as actually required, as long as the objectives of this application can be achieved. For example, the number of cycles undergone by the secondary battery may be 1, 2, 5, 10, 20, 30, 40, 50, 60, 70, 80, 90, 100, or a value falling within a range formed by any two thereof.

Generally, when the cold-pressing compaction density of the negative electrode material layer is the same, the value of the specific surface area S of the positive active material measured after cycling of the secondary battery may be changed by changing the specific surface area S1 of the raw material of the positive active material. When other conditions remain unchanged, when S1 increases, S increases; and, when S1 decreases, S decreases. When the specific surface area S1 of the raw material of the positive active material remains the same, the larger the value of the specific surface area S measured after cycling of the secondary battery, the greater the crumbling degree of the particles of the positive active material.

The “positive electrode material layer disposed on at least one surface of the positive current collector” means that the positive electrode material layer may be disposed on one surface of the positive current collector or on both surfaces of the positive current collector along the thickness direction of the current collector. It is hereby noted that the “surface” here may be the entire region of the surface of the positive current collector, or a partial region of the surface of the positive current collector, without being particularly limited herein, as long as the objectives of the application can be achieved. The positive current collector is not particularly limited herein, as long as the objectives of this application can be achieved. For example, the positive current collector may include aluminum foil, aluminum alloy foil, a composite current collector (such as an aluminum carbon composite current collector), or the like. The thicknesses of the positive current collector and the positive electrode material layer are not particularly limited herein, as long as the objectives of this application can be achieved. For example, the thickness of the positive current collector is 5 μm to 20 μm, preferably 6 μm to 18 μm. The thickness of the positive electrode material layer on a single side is 30 μm to 120 μm.

The positive active material is not particularly limited herein as long as the objectives of this application can be achieved. For example, the positive active material may include, but is not limited to, at least one selected from the group consisting of lithium nickel cobalt manganese oxide (for example, NCM811, NCM622, NCM523, NCM111), lithium iron phosphate, a lithium-rich manganese-based material, lithium cobalt oxide (LiCoO₂), lithium manganese oxide, lithium manganese iron phosphate, and lithium titanium oxide. The positive electrode material layer may include a positive conductive agent in addition to the positive electrode additive. The type of the positive conductive agent is not particularly limited herein, as long as the objectives of this application can be achieved. For example, the positive conductive agent may include, but is not limited to, at least one of conductive carbon black (Super P), carbon nanotubes (CNTs), carbon fibers, flake graphite, Ketjen black, graphene, a metal material, or a conductive polymer. The carbon nanotubes may include, but are not limited to, single-walled carbon nanotubes and/or multi-walled carbon nanotubes. The carbon fibers may include, but are not limited to, vapor grown carbon fibers (VGCF) and/or carbon nanofibers. The metal material may include, but is not limited to, metal powder and/or metal fibers. Specifically, the metal may include, but is not limited to, at least one selected from the group consisting of copper, nickel, aluminum, and silver. The conductive polymer may include, but is not limited to, at least one selected from the group consisting of polyphenylene derivatives, polyaniline, polythiophene, polyacetylene, and polypyrrole.

The method for preparing the positive electrode plate is not particularly limited herein, as long as the objectives of this application can be achieved. For example, the preparation method of the positive electrode plate may include, but is not limited to, the following steps: (1) mixing the positive active material, the fluorine-containing binder, the positive conductive agent, and the positive electrode additive, adding a solvent into the mixture, and stirring well to obtain a positive electrode slurry; (2) applying the positive electrode slurry onto one surface of the positive current collector, and oven-drying the slurry to form a positive electrode material layer on one surface of the positive current collector; (4) applying the positive electrode slurry onto the other surface of the positive current collector, and oven-drying the slurry to form a positive electrode material layer on both surfaces of the positive current collector; and (5) performing cold-pressing and cutting to obtain a positive electrode plate. The mass ratio between the positive active material, the fluorine-containing binder, the positive conductive agent, and the positive electrode additive is not particularly limited herein, and may be selected by a person skilled in the art as actually required, as long as the objectives of this application can be achieved. The solvent in the positive electrode slurry is not particularly limited herein, as long as the objectives of this application can be achieved. For example, the solvent may be N-methylpyrrolidone.

A third aspect of this application provides a secondary battery. The secondary battery includes a negative electrode plate, a separator, an electrolyte solution, and the positive electrode plate according to the second aspect of this application. The positive electrode plate provided in this application exhibits a relatively low expansion rate, so that the secondary battery provided in this application achieves a relatively high energy density and superior intermittent cycle performance.

In this application, the negative electrode plate is not particularly limited, as long as the objectives of this application can be achieved. For example, the negative electrode plate includes a negative current collector and a negative electrode material layer disposed on at least one surface of the negative current collector. The “negative electrode material layer disposed on at least one surface of the negative current collector” means that the negative electrode material layer may be disposed on one surface of the negative current collector or on both surfaces of the negative electrode current collector along the thickness direction of the current collector. It is hereby noted that the “surface” here may be the entire surface region of the negative current collector, or a partial surface region of the negative current collector, without being particularly limited herein, as long as the objectives of the application can be achieved. The negative current collector is not particularly limited herein, as long as the objectives of this application can be achieved. For example, the negative current collector may be copper foil, copper alloy foil, nickel foil, stainless steel foil, titanium foil, foamed nickel, foamed copper, a composite current collector (such as a lithium-copper composite current collector, a carbon-copper composite current collector, a nickel-copper composite current collector, or a titanium-copper composite current collector), or the like. The negative electrode material layer in this application includes a negative active material. The type of the negative active material is not particularly limited in this application, as long as the objectives of this application can be achieved. For example, the negative active material may include at least one selected from the group consisting of natural graphite, artificial graphite, mesocarbon microbeads (MCMB), hard carbon, soft carbon, silicon, a silicon-carbon composite, SiOₓ (0<x≤2), Li—Sn alloy, Li—Sn—O alloy, Sn, SnO, SnO₂, spinel-structured lithium titanium oxide Li₄Ti₅O₁₂, Li—Al alloy, and metallic lithium. The thicknesses of the negative current collector and the negative electrode material layer are not particularly limited herein, as long as the objectives of this application can be achieved. For example, the thickness of the negative current collector is 4 μm to 20 μm, and the thickness of the negative electrode material layer on a single side is 30 μm to 130 μm. Optionally, the negative electrode material layer may further include a negative conductive agent and a negative electrode binder. The type of the negative conductive agent is not particularly limited herein, as long as the objectives of this application can be achieved. For example, the type of the negative conductive agent may be the same as the positive conductive agent described above. The type of the negative electrode binder is not particularly limited herein, as long as the objectives of this application can be achieved. For example, the negative electrode binder may include, but is not limited to, at least one selected from the group consisting of polyvinylidene fluoride, poly(vinylidene fluoride-co-hexafluoropropylene), polyamide, polyacrylonitrile, polyacrylate, polyacrylic acid, polyacrylic acid sodium salt, polyvinylpyrrolidone, polyvinyl ether, polymethyl methacrylate, polytetrafluoroethylene, and polyhexafluoropropylene. The mass ratio between the negative active material, the negative conductive agent, and the negative electrode binder is not particularly limited herein, as long as the objectives of this application can be achieved.

The separator is not particularly limited herein, as long as the objectives of this application can be achieved. The substrate of the separator includes at least one selected from the group consisting of polyethylene (PE), polypropylene (PP), polyethylene terephthalate (PET), polyimide (PI), and aramid fiber. For example, the polyethylene includes constituents that are at least one selected from the group consisting of high-density polyethylene, low-density polyethylene, and ultra-high-molecular-weight polyethylene. The separator of this application may assume a porous structure. The pore size of the porous structure of the separator is not particularly limited herein, as long as the objectives of this application can be achieved. For example, the pore size may be 0.01 m to 1 m. The thickness of the separator is not particularly limited herein, as long as the objectives of this application can be achieved. For example, the thickness of the separator may be 5 m to 30 m.

The electrolyte solution in the secondary battery of this application includes a lithium salt and a nonaqueous solvent. The content of the lithium salt and the nonaqueous solvent in the electrolyte solution is not particularly limited herein, as long as the objectives of this application can be achieved. The lithium salt may include at least one selected from the group consisting of LiPF₆, LiNO₃, LiBF₄, LiClO₄, LiB(C₆H₅)₄, LiCH₃SO₃, LiCF₃SO₃, LiN(SO₂CF₃)₂, LiC(SO₂CF₃)₃, Li₂SiF₆, lithium bis(oxalato)borate (LiBOB), lithium bis(trifluoromethanesulfonyl)imide (LiTFSI), and lithium difluoroborate. The nonaqueous solvent is not particularly limited herein, as long as the objectives of this application can be achieved. For example, the nonaqueous solvent includes, but is not limited to, at least one selected from the group consisting of a carbonate ester compound, a carboxylate ester compound, an ether compound, and another organic solvent. The carbonate compound may include, but is not limited to, at least one selected from the group consisting of a chain carbonate compound, a cyclic carbonate compound, and a fluorocarbonate compound. The chain carbonate compound may include, but is not limited to, at least one selected from the group consisting of dimethyl carbonate, diethyl carbonate, dipropyl carbonate, methyl propyl carbonate, ethylene propyl carbonate, and ethyl methyl carbonate. The cyclic carbonate compound may include, but is not limited to, at least one selected from the group consisting of ethylene carbonate, propylene carbonate (PC), butylene carbonate, and vinyl ethylene carbonate. The fluorocarbonate compound may include, but is not limited to, at least one selected from the group consisting of fluoroethylene carbonate, 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, and trifluoromethyl ethylene carbonate. The carboxylate compound may include, but is not limited to, at least one selected from the group consisting of methyl formate, methyl acetate, ethyl acetate, n-propyl acetate, tert-butyl acetate, methyl propionate, ethyl propionate, propyl propionate, γ-butyrolactone, decanolactone, valerolactone, and caprolactone. The ether compound may include, but is not limited to, at least one selected from the group consisting of dibutyl ether, tetraglyme, diglyme, 1,2-dimethoxyethane, 1,2-diethoxyethane, 1-ethoxy-1-methoxyethane, 2-methyltetrahydrofuran, and tetrahydrofuran. The other organic solvent may include, but is not limited to, at least one selected from the group consisting of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, and trioctyl phosphate.

The secondary battery of this application further includes a packaging bag. The packaging bag is configured to accommodate a positive electrode plate, a negative electrode plate, a separator, an electrolyte solution, and other components known in the art for use in a secondary battery. Such other components are not limited herein. The packaging bag is not particularly limited herein, and may be a packaging bag well-known in the art, as long as the objectives of this application can be achieved.

The secondary battery is not particularly limited in this application, and may be any device in which an electrochemical reaction occurs. In an embodiment of this application, the secondary battery may be, but is not limited to, a lithium-ion secondary battery (lithium-ion battery), a lithium metal secondary battery, a lithium polymer secondary battery, a lithium-ion polymer secondary battery, or the like.

The method for preparing the secondary battery is not particularly limited herein, and may be any preparation method well-known in the art, as long as the objectives of this application can be achieved. For example, the method for preparing the secondary battery includes, but is not limited to, the following steps: stacking the positive electrode plate, the separator, the negative electrode plate, and the separator in sequence, and performing operations such as winding and folding as required on the stacked structure to obtain a jelly-roll electrode assembly; putting the electrode assembly into a pocket, injecting the electrolyte solution into the pocket, and sealing the pocket to obtain a secondary battery; or, stacking the positive electrode plate, the separator, the negative electrode plate, and the separator in sequence, and then fixing the four corners of the entire stacked structure to obtain a stacked-type electrode assembly, putting the electrode assembly into a pocket, injecting the electrolyte solution into the pocket, and sealing the pocket to obtain a secondary battery.

A fourth aspect of this application provides an electronic device. The electronic device includes the secondary battery according to the third aspect of this application. The secondary battery provided in this application possesses a relatively high energy density and superior intermittent cycle performance, and therefore, the electronic device provided in this application possesses a relatively long service life.

The electronic device is not particularly limited herein, and may be any electronic device known in the prior art. For example, the electronic device may include, but is not limited to, a laptop computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, or lithium-ion capacitor.

### EMBODIMENTS

The implementations of this application are described below in more detail with reference to embodiments and comparative embodiments. Various tests and evaluations are performed by the following methods. In addition, unless otherwise specified, the word “parts” means parts by mass, and the symbol “%” means a percentage by mass.

### Test Methods and Devices

### Method for Obtaining Samples of Positive Electrode Plates

Charging a lithium-ion battery in each embodiment and comparative embodiment at a rate of 0.2 C in a 25° C. environment until the voltage rises from 3 V to 4.52 V so that the battery reaches a fully charged state, and then discharging the battery at 0.2 C until the voltage drops to 3 V, thereby completing one charge-discharge cycle. Repeating the above operations on the lithium-ion battery for 20 cycles, and then disassembling the lithium-ion battery, taking out the positive electrode plate, wiping off the residual electrolyte solution on the surface of the positive electrode plate by using dust-free paper, soaking the positive electrode plate in dimethyl carbonate for 1 hour, and then taking out and air-drying the positive electrode plate to obtain a positive electrode plate sample.

### Determining the Glass Transition Temperature

The glass transition temperature (Tg) of the polymer represented by Formula I is determined according to the following process by using a differential scanning calorimeter (DSC): taking 10 mg of a powder sample of the polymer represented by Formula I, calibrating the DSC instrument, and loading the powder sample into a DSC sample box; at the same time, using a blank sample box as a blank control group; increasing the temperature from −30° C. to 150° C. at a heating rate of 10° C./min; and analyzing the temperature and heat changes in the resultant DSC curve to determine the glass transition temperature Tg of the polymer represented by Formula I.

### Determining the Compaction Density of the Positive Electrode Plate

Punching a cold-pressed positive electrode plate with a die of 1540.25 mm² in area to obtain 6 positive electrode plate samples. Using an analytical balance (an FA2004B electronic balance manufactured by Shanghai Jingke Tianmei) to measure the mass of the samples. Using a 0.1 μm resolution micrometer to measure the thickness of the samples. Weighing the 6 positive electrode plate samples to obtain a mass, and measuring the thickness of the samples. Scraping off the positive electrode material layer from each positive electrode plate, and then weighing the positive current collector and measuring the thickness of the positive current collector. Calculating the average thickness of the 6 samples to obtain an average thickness of the positive electrode material layers, denoted as H₁ mm, and to obtain the average thickness of the positive current collectors, denoted as H₂ mm, where the total mass of the 6 positive electrode material layers is M₁ g, and the total mass of the 6 positive current collectors is M₂ g. Compaction density of the cold-pressed positive electrode plate is: P₁=[(M₁−M₂)/6]/[(H₁−H₂)×1540.25/1000], in g/cm³.

The positive electrode plate samples obtained according to the above positive electrode plate sampling method are tested and calculated according to the above steps, so as to obtain the compaction density P₂ of the cycled positive electrode plate, in g/cm³.

### Determining the Cohesive Force of the Positive Electrode Material Layer

The positive electrode plate samples are obtained according to the above positive electrode plate sampling method. The positive electrode plate samples are punched with a die to obtain test strips of 120 mm in length and 30 mm in width. Wiping the surface of a steel sheet clean by using ethanol, sticking double-sided tape (NITTO, NO5000NS) of 100 mm in length and 20 mm in width onto the steel sheet. Sticking the test strip onto a middle part of the double-sided tape, with the test side facing down. Sticking green tape (adhesive tape from Tuodi Chemical Ltd., 100 mm long, 20 mm wide) to the middle part of the test strip, cutting out a paper strip 100 mm long and 30 mm wide, and inserting the paper strip between the test strip and the green tape, with an overlap length of 15 mm. Pushing a 2 kg rubber roller manually to roll back and forth over the test strip 4 times to obtain a specimen for test. Testing the specimen by using a tensile tester (Instron 3365, from Sansi). Fixing the specimen onto a specimen platform, folding the paper strip upward by 180°, and fixing the paper strip with a jig. Subsequently, using the tensile tester to pull the paper strip slowly at a speed of 10 mm/min until the green tape is detached from the positive electrode material layer on the surface of the positive electrode, whereupon the test is finished. Averaging out the tensile force values measured in a steady region, and recording the average value as a cohesive force of the positive electrode material layer, in units of N/m.

### Determining the Specific Surface Area of the Positive Active Material

Obtaining a positive electrode plate sample according to the above positive electrode plate sampling method. Placing the positive electrode plate sample into a muffle furnace, and baking the sample at 600° C. for 2 hours. Cooling the muffle furnace to room temperature, and then taking out the baked positive electrode plate sample. Collecting the positive active material powder, and then measuring the specific surface area of the positive active material powder by use of a specific surface area analyzer (TriStar II 3020M, supplied by Micromeritics USA) by using a nitrogen adsorption method with reference to the national standard GB/T 19587-2017 Determination of Specific Surface Area of Solids By Gas Adsorption Using BET Method, so as to obtain the specific surface area of the positive active material.

### X-Ray Diffraction Test

Obtaining a positive electrode plate sample according to the above positive electrode plate sampling method. Scraping off the positive electrode material layer, and then grinding the positive electrode material layer to obtain positive electrode material layer powder, and then obtaining an X-ray diffraction pattern of the positive electrode material layer powder by using an X-ray diffraction analyzer. Performing the test by using a Cu Kα ray, where the scanning range of the diffraction angle is 120 to 160°.

### Intermittent Cycle Performance Test

Performing the test in a 45° C. thermostat according to the following process by using a multi-channel battery test system supplied by Wuhan LAND Electronics Co., Ltd.: charging a lithium-ion battery at a constant current of 0.7 C until the voltage reaches 4.52 V, and then charging the battery at a constant voltage of 4.52 V until the current drops to 0.05 C; leaving the battery to stand at 45° C. for 21 hours, and then discharging the battery at a current of 0.5 C until the voltage drops to 3 V, thereby completing one cycle; and recording the first-cycle discharge capacity of the lithium-ion battery. Regarding the first-cycle discharge capacity as 100% full capacity, repeating the above charge and discharge operations cyclically until the capacity retention rate of the lithium-ion battery fades to 80% of the full capacity, and recording the number of cycles at this time, that is, the number of intermittent cycles corresponding to the 80% capacity retention rate.

### Determining the Energy Density

Measuring the volume V of the lithium-ion battery by using a water displacement method. Performing the test in a 25° C. environment according to the following process by using a multi-channel battery test system supplied by Wuhan LAND Electronics Co., Ltd.: charging a lithium-ion battery at a constant current of 0.7 C until the voltage reaches 4.52 V, and then charging the battery at a constant voltage of 4.52 V until the current drops to 0.05 C; and then discharging the battery at a current of 0.5 C until the voltage drops to 3 V; and recording the discharge energy W of the lithium-ion battery, and calculating the volumetric energy density of the lithium-ion battery as: volumetric energy density=W/V, in units of Wh/L.

### Embodiment 1-1

### <Positive Electrode Additive>

Using the polymer represented by Formula I as a positive electrode additive. In the formula, m=300, n=162, and the number-average molecular weight of the polymer is 6.7×10⁴.

### <Preparing a Positive Electrode Plate>

Mixing lithium cobalt oxide (LiCoO₂, the specific surface area of the raw material is S1=0.1 m²/g) as a positive active material, polyvinylidene difluoride (PVDF) as a fluorine-containing binder, conductive carbon black, and the above positive electrode additive at a mass ratio of 97.6:1.2:1.1:0.1. Dispersing the mixture into N-methyl-pyrrolidone, and stirring the mixture well to obtain a positive electrode slurry in which the solid content is 71 wt %. Coating one surface of a 9 μm-thick positive current collector aluminum foil with the positive electrode slurry evenly, and drying the slurry at 120° C. to obtain a positive electrode plate coated with a 75 μm-thick positive active material layer on a single side. Subsequently, repeating the foregoing steps on the other surface of the positive current collector aluminum foil to obtain a positive electrode plate coated with the positive active material layer on both sides. Cold-pressing and cutting the coated positive electrode plate into sheets of 70 mm×800 mm for future use.

### <Preparing a Negative Electrode Plate>

Mixing artificial graphite as a negative active material, sodium carboxymethyl cellulose as a dispersant, conductive carbon black as a negative conductive agent, and styrene-butadiene rubber as a binder at a mass ratio of 95:2:1:2, and then adding deionized water as a solvent, and stirring well to obtain a negative electrode slurry in which the solid content is 70 wt %. Coating one surface of a 6 μm-thick negative current collector copper foil with the negative electrode slurry evenly, and drying the slurry at 120° C. to obtain a negative electrode plate coated with a 110 m-thick negative electrode material layer on a single side. Subsequently, repeating the foregoing step on the other surface of the negative current collector copper foil to obtain a negative electrode plate coated with the negative electrode material layer on both sides. Cold-pressing and cutting the coated negative electrode plate into sheets of 74 mm×810 mm for future use. The compaction density of the negative electrode material layer is 1.76 g/cm³.

### <Preparing an Electrolyte Solution>

Mixing propylene carbonate (PC), diethyl carbonate (DEC), and ethylene carbonate (EC) at a mass ratio of 1:1:1 in a dry argon atmosphere glovebox to form a nonaqueous solvent, and then adding hexafluorophosphate (LiPF₆) as a lithium salt into the nonaqueous solvent to dissolve, and stirring well to obtain an electrolyte solution. Based on the mass of the electrolyte solution, the mass percent of LiPF₆ is 12%, and the remainder is the nonaqueous solvent.

### <Preparing a Separator>

Using a 5 μm-thick porous polyethylene film (supplied by Celgard) as a separator.

### <Preparing a Lithium-Ion Battery>

Stacking the above-prepared positive electrode plate, separator, negative electrode plate, and separator in sequence, and then winding the stacked structure to obtain an electrode assembly. Welding tabs, and putting the electrode assembly into an aluminum laminated film, dehydrating the packaged electrode assembly in an 80° C. vacuum oven for 12 hours, and then injecting the above-prepared electrolyte solution. Performing steps such as vacuum sealing, standing, chemical formation, capacity grading, and shaping to obtain a lithium-ion battery.

### Embodiments 1-2 to 1-5

Identical to Embodiment 1-1 except that the parameters are adjusted according to Table 1.

### Embodiments 2-1 to 2-5

Identical to Embodiment 1-1 except that the parameters are adjusted according to Table 2. The mass percent of the positive active material changes with the mass percent of the positive electrode additive.

### Embodiments 2-6 to 2-8

Identical to Embodiment 1-1 except that the parameters are adjusted according to Table 2. By adjusting the specific surface area S1 of the raw material of the positive active material, the value of the specific surface area S of the positive active material measured after cycling of the secondary battery can be changed to the value set out in Table 2.

### Embodiments 2-9 to 2-13

Identical to Embodiment 1-1 except that the parameters are adjusted according to Table 2. The mass percent of the positive active material changes with the mass percent of the fluorine-containing binder.

### Comparative Embodiments 1-1 to 1-3

Identical to Embodiment 1-1 except that the parameters are adjusted according to Table 1.

### Comparative Embodiments 2-1 to 2-4

Identical to Embodiment 1-1 except that the parameters are adjusted according to Table 2.

Table 1 to Table 2 show the preparation parameters and performance parameters of each embodiment and each comparative embodiment.

TABLE 1

| | | | Number- | | | | | | | | |
|---|---|---|---|---|---|---|---|---|---|---|---|
| | | | average | | | | | | | Number of | Energy |
| | | | molecular | | | | P₁ | P₂ | Cohesive | intermittent | density |
| | m | n | weight | m/n | Tg (° C.) | S (m²/g) | (g/cm³) | (g/cm³) | force (N/m) | cycles (cls) | (Wh/L) |
| Embodiment 1-1 | 300 | 162 | 6.7 × 10⁴ | 1.85 | −8 | 0.24 | 4.23 | 4.05 | 45.3 | 71 | 691.94 |
| Embodiment 1-2 | 16000 | 8000 | 3.5 × 10⁶ | 2 | 4 | 0.24 | 4.23 | 4.05 | 48.6 | 72 | 691.74 |
| Embodiment 1-3 | 704000 | 320000 | 1.6 × 10⁸ | 2.2 | 10 | 0.24 | 4.23 | 4.05 | 49.3 | 70 | 691.64 |
| Embodiment 1-4 | 19200 | 8000 | 4.2 × 10⁶ | 2.4 | −13 | 0.24 | 4.23 | 4.05 | 48.4 | 71 | 692.01 |
| Embodiment 1-5 | 24000 | 8000 | 5.1 × 10⁶ | 3 | −20 | 0.24 | 4.23 | 4.05 | 50.2 | 72 | 692.34 |
| Comparative | 200 | 162 | 4.8 × 10⁴ | 1.23 | −9 | 0.26 | 4.28 | 4.05 | 26.1 | 43 | 669.64 |
| Embodiment 1-1 | | | | | | | | | | | |
| Comparative | 400 | 100 | 8.4 × 10⁴ | 4 | 2 | 0.26 | 4.28 | 4.05 | 29.5 | 48 | 670.64 |
| Embodiment 1-2 | | | | | | | | | | | |
| Comparative | 1400000 | 470000 | 3 × 10⁸ | 3 | 20 | 0.26 | 4.28 | 4.05 | 21.9 | 44 | 673.17 |
| Embodiment 1-3 | | | | | | | | | | | |

As can be seen from Embodiments 1-1 to 1-5 and Comparative Embodiments 1-1 to 1-3, by controlling the values of m and n and the number-average molecular weight of the polymer represented by Formula I to fall within the ranges specified herein, the polymer represented by Formula I can exhibit a relatively low glass transition temperature, and the positive active material can possess a relatively low specific surface area, indicating that the crumbling degree of the positive active material is relatively low, and the positive electrode material layer possesses a relatively high cohesive force. When the capacity retention rate of the lithium-ion battery fades to 80%, the number of intermittent cycles is relatively large, and the energy density is relatively high, indicating that the secondary battery exhibits good intermittent cycle performance and a relatively high energy density.

The values of m and n typically affect the intermittent cycle performance and energy density of the secondary battery. As can be seen from Embodiments 1-1 to 1-5 and Comparative Embodiments 1-1 and 1-2, if m is excessively small as in Comparative Embodiment 1-1, the content of the catechol-modified group is excessively low and the content of the acrylonitrile group is excessively high, the cohesive force of the positive electrode material layer is made small, and the thickness of the positive electrode plate is made large, thereby being detrimental to the increase of the energy density of the secondary battery. When the value of n is excessively small as in Comparative Embodiment 1-2, the content of the acrylonitrile group is excessively low and the content of the catechol-modified group is excessively high, and the positive electrode plate is made brittle, thereby resulting in a narrower range of brittleness tolerance of the positive electrode plate after cold-pressing. This is detrimental to the processing performance of the positive electrode plate. By controlling the values of m and n within the ranges specified herein, the positive electrode material layer can possess a relatively high cohesive force, and, when the capacity retention rate of the lithium-ion battery fades to 80%, the number of intermittent cycles is relatively large, and the energy density is relatively high, indicating that the secondary battery exhibits good intermittent cycle performance and a relatively high energy density.

The number-average molecular weight of the polymer represented by Formula I typically affects the intermittent cycle performance and energy density of the secondary battery. As can be seen from Embodiments 1-1 to 1-3 and Comparative Embodiments 1-1 and 1-3, when the number-average molecular weight of the polymer represented by Formula I is excessively small as in Comparative Embodiment 1-1, the cohesive force of the positive electrode material layer is excessively small, and, when the capacity retention rate of the lithium-ion battery fades to 80%, the number of intermittent cycles is relatively small, and the energy density is relatively low. When the number-average molecular weight of the polymer represented by Formula I is excessively large as in Comparative Embodiment 1-3, the cohesive force of the positive electrode material layer is also relatively small, and, when the capacity retention rate of the lithium-ion battery fades to 80%, the number of intermittent cycles is relatively small, and the energy density is relatively low. The applicant hereof speculates that when the number-average molecular weight of the polymer represented by Formula I is excessively large, the crosslinkability of the positive electrode additive is excessively high, and the hydroxyl group on the benzene ring in the polymer represented by Formula I is suppressed. Consequently, the formed strong hydrogen bonds are relatively few, and the cohesive force of the positive electrode material layer is not strong enough to alleviate the expansion of the positive electrode plate, thereby being detrimental to improvement of the intermittent cycle performance and energy density of the lithium-ion battery. By controlling the number-average molecular weight of the polymer represented by Formula I to fall within the range specified herein, the positive electrode material layer can possess a relatively high cohesive force, and, when the capacity retention rate of the lithium-ion battery fades to 80%, the number of intermittent cycles is relatively large, and the energy density is relatively high, indicating that the secondary battery exhibits good intermittent cycle performance and a relatively high energy density.

TABLE 2

| | | | | | | Quadruple | | | | | |
|---|---|---|---|---|---|---|---|---|---|---|---|
| | | | | | | characteristic | | | | | |
| | | | | Fluorine- | | peaks | | | Cohesive | Number of | Energy |
| | | | | containing | | exhibited in | P₁ | P₂ | force | intermittent | density |
| | A (%) | S (m²/g) | A × S | binder | B (%) | 40° to 55° | (g/cm³) | (g/cm³) | (N/m) | cycles (cls) | (Wh/L) |
| Embodiment 1-1 | 0.1 | 0.24 | 0.024 | PVDF | 1.2 | Yes | 4.23 | 4.05 | 45.3 | 71 | 691.94 |
| Embodiment 2-1 | 0.2 | 0.24 | 0.048 | PVDF | 1.2 | Yes | 4.23 | 4.05 | 61.9 | 72 | 689.17 |
| Embodiment 2-2 | 0.3 | 0.24 | 0.072 | PVDF | 1.2 | Yes | 4.23 | 4.06 | 71.6 | 74 | 686.14 |
| Embodiment 2-3 | 0.4 | 0.24 | 0.096 | PVDF | 1.2 | Yes | 4.23 | 4.08 | 80.0 | 73 | 687.59 |
| Embodiment 2-4 | 0.5 | 0.24 | 0.12 | PVDF | 1.2 | Yes | 4.23 | 4.10 | 93.2 | 72 | 693.14 |
| Embodiment 2-5 | 0.6 | 0.24 | 0.144 | PVDF | 1.2 | Yes | 4.21 | 4.06 | 91.4 | 71 | 680.14 |
| Embodiment 2-6 | 0.2 | 0.1 | 0.02 | PVDF | 1.2 | Yes | 4.23 | 4.05 | 45.8 | 75 | 690.89 |
| Embodiment 2-7 | 0.1 | 1 | 0.1 | PVDF | 1.2 | Yes | 4.23 | 4.05 | 44.7 | 69 | 689.76 |
| Embodiment 2-8 | 0.5 | 0.3 | 0.15 | PVDF | 1.2 | Yes | 4.23 | 4.10 | 94.1 | 70 | 694.01 |
| Embodiment 2-9 | 0.1 | 0.24 | 0.024 | AlF₃ | 1.2 | Yes | 4.23 | 3.97 | 41.9 | 35 | 663.17 |
| Embodiment 2-10 | 0.1 | 0.24 | 0.024 | PTFE | 1.2 | Yes | 4.23 | 3.94 | 71.6 | 42 | 671.14 |
| Embodiment 2-11 | 0.1 | 0.24 | 0.024 | PVDF-HFP | 1.2 | Yes | 4.23 | 3.99 | 53.2 | 59 | 669.64 |
| Embodiment 2-12 | 0.1 | 0.24 | 0.024 | PVDF | 0.8 | Yes | 4.23 | 4.05 | 47.1 | 71 | 691.4 |
| Embodiment 2-13 | 0.1 | 0.24 | 0.024 | PVDF | 1.5 | Yes | 4.23 | 4.06 | 52.1 | 71 | 686.2 |
| Comparative | 0 | 0.26 | 0 | PVDF | 1.3 | No | 4.28 | 4.05 | 32.3 | 65 | 674.14 |
| Embodiment 2-1 | | | | | | | | | | | |
| Comparative | 0 | 0.24 | 0 | PVDF | 1.3 | No | 4.23 | 3.90 | 26.3 | 67 | 678.89 |
| Embodiment 2-2 | | | | | | | | | | | |
| Comparative | 0.1 | 0.24 | 0.024 | Polyacrylic | 1.2 | No | 4.10 | 3.45 | 18.7 | 34 | 612.23 |
| Embodiment 2-3 | | | | acid | | | | | | | |
| Comparative | 0 | 0.26 | 0 | PTFE | 1.3 | No | 4.28 | 3.85 | 30.9 | 36 | 622.7 |
| Embodiment 2-4 | | | | | | | | | | | |

As can be seen from Embodiment 1-1 and Comparative Embodiments 2-1 to 2-4, the positive electrode material layer contains both a fluorine-containing binder and a positive electrode additive, and the XRD pattern of the powder of the positive electrode material layer exhibits quadruple characteristic peaks in the diffraction angle range of 400 to 550, thereby contributing to a higher compaction density of the positive electrode plate after cycling and a higher cohesive force. Therefore, when the capacity retention rate of the lithium-ion battery fades to 80%, the number of intermittent cycles is relatively large, and the energy density is relatively high, indicating that the secondary battery exhibits good intermittent cycle performance and a relatively high energy density. In Comparative Embodiments 2-1, 2-2, and 2-4, the positive electrode material layer contains no positive electrode additive, and in Comparative Embodiment 2-3, the positive electrode material layer contains no fluorine-containing binder. Therefore, the XRD pattern of the powder of the positive electrode material layer exhibits no quadruple characteristic peaks in the diffraction angle range of 400 to 55°. In Comparative Embodiments 2-1 to 2-4, when the capacity retention rate of the lithium-ion battery fades to 80%, the number of intermittent cycles is relatively small, and the energy density is relatively low, indicating relatively low intermittent cycle performance and a relatively low energy density of the secondary battery.

As can be seen from Embodiment 1-1 versus Comparative Embodiment 2-1, when the positive electrode plates possess the same after-cycling compaction density P₂, the positive electrode plate in Comparative Embodiment 2-1 that contains no positive electrode additive of this application needs to be implemented by setting a higher after-cold-pressing compaction density P₁. The increase in the after-cold-pressing compaction density P₁ causes an increase in the crumbling degree of the positive active material. This is manifested in the larger specific surface area of the positive active material in Comparative Embodiment 2-1, and therefore, is detrimental to improvement of the cycle performance and energy density of the lithium-ion battery. As can be seen from Embodiment 1-1 versus Comparative Embodiment 2-2, when the positive electrode plates possess the same after-cold-pressing compaction density P₁, the positive electrode plate in Comparative Embodiment 2-2 that contains no positive electrode additive of this application possesses an excessively low after-cycling compaction density P₂, and fails to alleviate the expansion problem. This results in a relatively large thickness of the positive electrode plate, and is detrimental to improvement of the energy density of the lithium-ion battery.

The mass percent A % of the positive electrode additive typically affects the intermittent cycle performance and energy density of the secondary battery. As can be seen from Embodiment 1-1 and Embodiments 2-1 to 2-5, by controlling the value of A within the range specified herein, the positive electrode material layer can possess a relatively high cohesive force, and, when the capacity retention rate of the lithium-ion battery fades to 80%, the number of intermittent cycles is relatively large, and the energy density is relatively high, indicating that the secondary battery exhibits good intermittent cycle performance and a relatively high energy density. In contrast to Embodiment 2-4, in Embodiment 2-5, due to the further increase in the mass percent of the positive electrode additive, the mass percent of the positive active material decreases accordingly. At the same time, the cold-pressing compaction density of the positive electrode plate is reduced, and the cohesive force of the positive electrode material layer is reduced. The combined effect of the above factors reduces the energy density in Embodiment 2-5.

The values of S and A×S typically affect the intermittent cycle performance and energy density of the secondary battery. As can be seen from Embodiment 1-1 and Embodiments 2-1 to 2-8, by controlling the values of S and A×S within the range specified herein, the positive electrode material layer can possess a relatively high cohesive force, and, when the capacity retention rate of the lithium-ion battery fades to 80%, the number of intermittent cycles is relatively large, and the energy density is relatively high, indicating that the secondary battery exhibits good intermittent cycle performance and a relatively high energy density.

The type of the fluorine-containing binder typically affects the intermittent cycle performance and energy density of the secondary battery. As can be seen from Embodiment 1-1 and Embodiments 2-9 to 2-11, the fluorine-containing binder falling within the range specified herein endows the positive electrode material layer with a relatively high cohesive force. Therefore, when the capacity retention rate of the lithium-ion battery fades to 80%, the number of intermittent cycles is relatively large, and the energy density is relatively high, indicating that the secondary battery exhibits good intermittent cycle performance and a relatively high energy density.

The mass percent B % of the fluorine-containing binder typically affects the intermittent cycle performance and energy density of the secondary battery. As can be seen from Embodiment 1-1 and Embodiments 2-12 to 2-13, by controlling the value of B within the range specified herein, the positive electrode material layer can possess a relatively high cohesive force, and, when the capacity retention rate of the lithium-ion battery fades to 80%, the number of intermittent cycles is relatively large, and the energy density is relatively high, indicating that the secondary battery exhibits good intermittent cycle performance and a relatively high energy density.

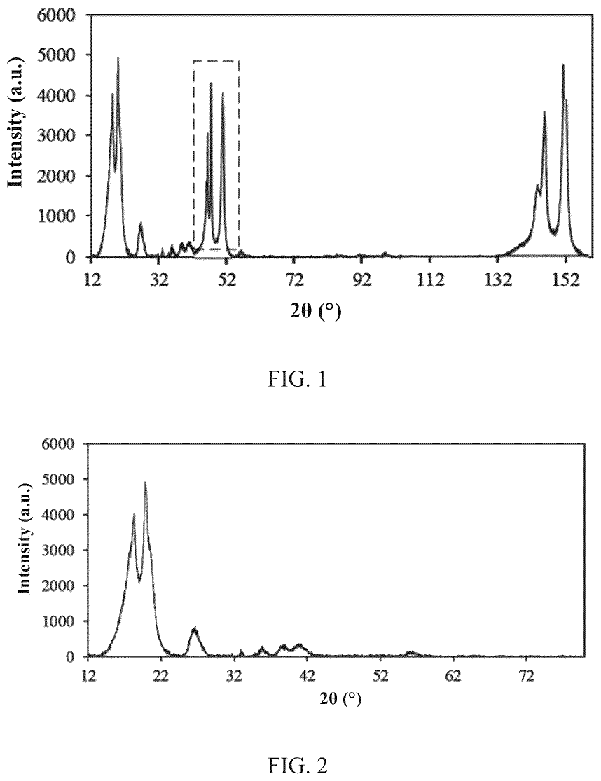

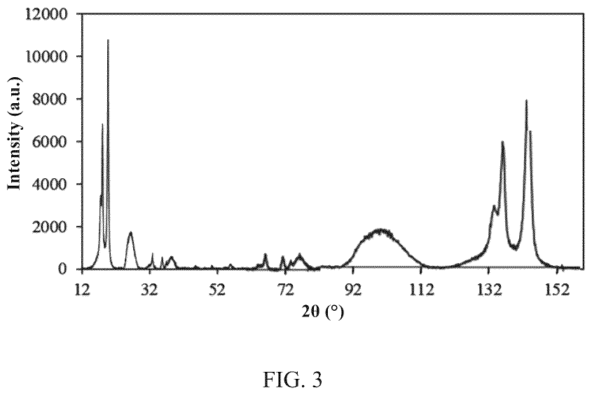

FIG. 1 is an X-ray diffraction pattern of powder of a positive electrode material layer according to Embodiment 1-1. As shown in FIG. 1, the X-ray diffraction pattern of the powder of the positive electrode material layer in Embodiment 1-1 exhibits quadruple characteristic peaks in a diffraction angle range of 400 to 55°, as shown by the dashed box, indicating that strong hydrogen bonds exist in the positive electrode material layer. FIG. 2 is an X-ray diffraction pattern of PVDF powder, and FIG. 3 is an X-ray diffraction pattern of powder of a positive electrode additive according to Embodiment 1-1. FIG. 2 and FIG. 3 show that no quadruple characteristic peaks are exhibited in the X-ray diffraction pattern of the positive electrode additive used in Embodiment 1-1. As can be seen, when the positive electrode material layer contains both a fluorine-containing binder and a positive electrode additive, strong hydrogen bonds exist in the positive electrode material layer.

It is hereby noted that, as used herein, the terms “include”, “comprise”, and any variation thereof are intended to cover a non-exclusive inclusion relationship by which a process, method, or object that includes or comprises a series of elements not only includes such elements, but also includes other elements not expressly specified or also includes inherent elements of the process, method, or object.

Different embodiments of this application are described in a correlative manner. For the same or similar part in one embodiment, reference may be made to another embodiment. Each embodiment focuses on differences from other embodiments.

What is described above is merely exemplary embodiments of this application, but is not intended to limit this application. Any modifications, equivalent replacements, improvements, and the like made without departing from the spirit and principles of this application still fall within the protection scope of this application.

What is claimed is:

1. A positive electrode plate, comprising a positive current collector and a positive electrode material layer disposed on at least one surface of the positive current collector, the positive electrode material layer comprises a positive electrode material; the positive electrode material comprises a positive active material, a fluorine-containing binder, and a positive electrode additive; the positive electrode additive comprising a polymer represented by Formula I: 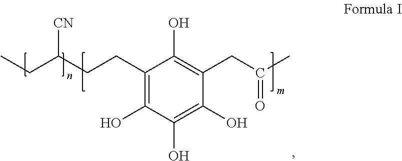
wherein, n≥162, m≥300, and a number-average molecular weight of the polymer is 6.7×10⁴ to 2×10⁸.

2. The positive electrode plate according to claim 1, wherein 1.85≤m/n≤3.

3. The positive electrode plate according to claim 1, wherein a glass transition temperature of the polymer is −20° C. to 10° C.

4. The positive electrode plate according to claim 1, wherein a mass percentage of the positive electrode additive is A %, and 0.1≤A≤0.5.

5. The positive electrode plate according to claim 4, wherein a specific surface area of the positive active material is S m²/g, 0.1≤S≤1, and 0.02≤A×S≤0.15.

6. The positive electrode plate according to claim 1, wherein the fluorine-containing binder comprises at least one selected from the group consisting of aluminum trifluoride, polytetrafluoroethylene, poly(vinylidene fluoride-co-hexafluoropropylene), and polyvinylidene fluoride; and
based on a mass of the positive electrode material layer, a mass percentage of the fluorine-containing binder is B %, 0.8≤B≤1.5.

7. The positive electrode plate according to claim 1, wherein an X-ray diffraction pattern of powder of the positive electrode material layer exhibits quadruple characteristic peaks in a diffraction angle range of 400 to 55°.

8. The positive electrode plate according to claim 1, wherein a cohesive force of the positive electrode material layer is 45 N/m to 95 N/m.

9. A secondary battery, comprising a positive current collector and a positive electrode material layer disposed on at least one surface of the positive current collector, the positive electrode material layer comprises a positive electrode material; the positive electrode material comprises a positive active material, a fluorine-containing binder, and a positive electrode additive; the positive electrode additive comprising a polymer represented by Formula I: 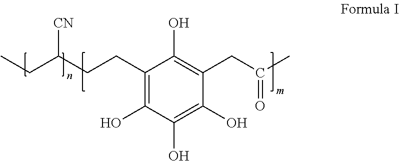
wherein, n≥162, m≥300, and a number-average molecular weight of the polymer is 6.7×10⁴ to 2×10⁸.

10. The secondary battery according to claim 9, wherein 1.85≤m/n≤3.

11. The secondary battery according to claim 9, wherein a glass transition temperature of the polymer is −20° C. to 10° C.

12. The secondary battery according to claim 9, wherein a mass percent of the positive electrode additive is A %, and 0.1≤A≤0.5.

13. The secondary battery according to claim 12, wherein a specific surface area of the positive active material is S m²/g, 0.1≤S≤1, and 0.02≤A×S≤0.15.

14. The secondary battery according to claim 9, wherein the fluorine-containing binder comprises at least one selected from the group consisting of aluminum trifluoride, polytetrafluoroethylene, poly(vinylidene fluoride-co-hexafluoropropylene), and polyvinylidene fluoride; and
based on a mass of the positive electrode material layer, a mass percent of the fluorine-containing binder is B %, 0.8≤B≤1.5.

15. The secondary battery according to claim 9, wherein an X-ray diffraction pattern of powder of the positive electrode material layer exhibits quadruple characteristic peaks in a diffraction angle range of 40° to 55°.

16. An electronic device, comprising a secondary battery, the secondary battery comprises a positive current collector and a positive electrode material layer disposed on at least one surface of the positive current collector, the positive electrode material layer comprises a positive electrode material; the positive electrode material comprises a positive active material, a fluorine-containing binder, and a positive electrode additive; the positive electrode additive comprising a polymer represented by Formula I: 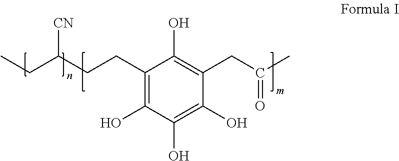
wherein, n≥162, m≥300, and a number-average molecular weight of the polymer is 6.7×10⁴ to 2×10⁸.

17. The electronic device according to claim 16, wherein 1.85≤m/n≤3.

18. The electronic device according to claim 16, wherein a mass percent of the positive electrode additive is A %, 0.1≤A≤0.5.

19. The electronic device according to claim 18, wherein a specific surface area of the positive active material is S m²/g, 0.1≤S≤1, and 0.02≤A×S≤0.15.

20. The electronic device according to claim 16, wherein an X-ray diffraction pattern of powder of the positive electrode material layer exhibits quadruple characteristic peaks in a diffraction angle range of 40° to 55°.
